(19) United States
(12) Patent Application Publication
(10) Pub. No.: US 2025/0108740 A1
(43) Pub. Date: Apr. 3, 2025

(54) SEAT, DISASSEMBLING AND ASSEMBLING METHOD THEREFOR, AND BACKREST MODULE

(71) Applicant: FAURECIA (CHINA) HOLDING CO., LTD., Shanghai (CN)

(72) Inventors: Weiwei Jiang, Shanghai (CN); Ya Fang, Shanghai (CN); Huaqian He, Shanghai (CN); Lei Xiang, Shanghai (CN); Shuqin Mo, Shanghai (CN)

(73) Assignee: FAURECIA (CHINA) HOLDING CO., LTD., Shanghai (CN)

(21) Appl. No.: 18/900,945

(22) Filed: Sep. 30, 2024

(30) Foreign Application Priority Data
Sep. 28, 2023 (CN) 202311280297.7

(51) Int. Cl. B60N 2/64; B60N 2/58; B60N 2/68

(52) U.S. Cl. CPC B60N 2/64; B60N 2/58; B60N 2/682

(57) ABSTRACT

The present disclosure provides a seat, a disassembling and assembling method therefor, and a backrest module. The seat includes a backrest skeleton, and a backrest module, being able to detachably connect to the backrest skeleton as a whole, to form a backrest part of the seat; and the backrest module includes a frame, and the frame includes a frame body and a frame connecting portion, and the frame body is located within an area limited by the backrest skeleton; and the frame connecting portion is able to connect with a skeleton connecting portion of the backrest skeleton, making the backrest module be able to detachably connect to the backrest skeleton; and the frame connecting portion includes a first portion and a second portion connected with the first portion.

### FIELD

The present disclosure relates to a seat, a disassembling and assembling method therefor, and a backrest module.

### BACKGROUND

A seat generally includes a backrest and a cushion. The backrest is generally used to support a passenger's back.

For backrest, it is generally hard to replace, that is, the backrest is generally unchanged during service life of a seat, and if the backrest is damaged, the entire seat should be replaced.

Therefore, it is difficult to meet individual needs of users.

Therefore, a seat, a disassembling and assembling method, and a backrest module are needed to meet the individual needs of seat users.

### SUMMARY

The present disclosure provides a seat.

The present disclosure provides a disassembling and assembling method for a seat.

The present disclosure provides a backrest module.

The present disclosure provides a seat according to embodiments of the disclosure. The seat includes a backrest skeleton, and a backrest module, being able to detachably connect to the backrest skeleton as a whole, to form a backrest part of the seat; and the backrest module includes a frame, and the frame includes a frame body and a frame connecting portion, and the frame body is located within an area limited by the backrest skeleton; and the frame connecting portion is able to connect with a skeleton connecting portion of the backrest skeleton, making the backrest module be able to detachably connect to the backrest skeleton; and the frame connecting portion includes a first portion and a second portion connected with the first portion, and the first portion and the second portion are respectively located on a first side and a second side opposite to the first side of the skeleton connecting portion; and the first portion includes a first connecting structure, and the skeleton connecting portion includes a second connecting structure; and the first connecting structure is able to correspondingly connect with the second connecting structure, making the frame connecting portion be able to connect with the skeleton connecting portion of the backrest skeleton.

Further, in some embodiments of the present disclosure, the first connecting structure includes a clamping member, the second connecting structure includes a first opening, and the clamping member is set to engage the first opening.

Further, in some embodiments of the present disclosure, the clamping member includes a first elastic tongue and a second elastic tongue that are oppositely arranged, and the first elastic tongue and the second elastic tongue respectively engage a first opening edge and a second opening edge oppositely set to the first opening edge of the first opening by elastic force.

Further, in some embodiments of the present disclosure, the first portion includes a first portion base, and the clamping member is arranged on the first portion base, and the first portion base is able to rotate relative to the second porting, making the first connecting structure is able to be connected or disconnected from the second connecting structure.

Further, in some embodiments of the present disclosure, the first portion base is connected with the second portion through a thinned portion, and thickness of the thinned portion is thinned relative to thickness of the first portion base, and the first portion base can rotate relative to the second porting with the thinned portion as a rotating shaft.

Further, in some embodiments of the present disclosure, the second portion and the skeleton connecting portion are both plate-shaped structure.

Further, in some embodiments of the present disclosure, the backrest module further includes a surface cover, and part of the surface cover is located between the first side of the skeleton connecting portion and the first portion, and when the first connecting structure is connected with the second connecting structure, part of the surface cover is located between the first connecting structure and the second connecting structure, making the first connecting structure and the second connecting structure be arranged without direct contact.

In addition, the present disclosure provides a disassembling and assembling method for a seat, being used for the seat of the above embodiments, and the backrest module includes a frame and a surface cover, and the disassembling and assembling method includes: connecting or disconnecting the first connecting structure from the second connecting structure to assemble or disassemble the backrest module with the backrest skeleton.

In addition, the present disclosure provides a backrest module, being able to detachably connect to a backrest skeleton as a whole to form a backrest part of a seat, and the backrest module includes a frame, and the frame includes a frame body and a frame connecting portion, and the frame body is located within an area limited by the backrest skeleton; and the frame connecting portion is able to connect with a skeleton connecting portion of the backrest skeleton, making the backrest module be able to detachably connect to the backrest skeleton; and the frame connecting portion includes a first portion and a second portion connected with the first portion, and the first portion and the second portion are respectively located on a first side and a second side opposite to the first side of the skeleton connecting portion; and the first portion includes a first connecting structure, and the skeleton connecting portion includes a second connecting structure; and the first connecting structure is able to correspondingly connect with the second connecting structure, making the frame connecting portion be able to connect with the skeleton connecting portion of the backrest skeleton.

Further, in some embodiments of the present disclosure, the backrest module further includes a surface cover, and the surface cover is located on a side which the first portion corresponds to the skeleton connecting portion and the cover extends to an area corresponding to the first portion.

### DESCRIPTION OF ATTACHED DRAWINGS

The above embodiments of the present disclosure will be better understood after reading the detailed description of the embodiments of the present disclosure in conjunction with the following figures. In the figures, components are not necessarily drawn to scale, and components having similar related features may have the same or similar reference numerals.

FIG. 1 is an exploded view structural diagram of a seat provided in accordance with some embodiments of the present disclosure.

FIG. 2 is a structural diagram of a frame of a backrest module provided in accordance with some embodiments of the present disclosure.

FIG. 3A is a structural diagram of a frame connecting portion of a backrest module in a disconnected status accordance with some embodiments of the present disclosure.

FIG. 3B is a structural diagram of a frame connecting portion of a backrest module and a skeleton connecting portion of a backrest skeleton in a disconnected status accordance with some embodiments of the present disclosure.

FIG. 4A is a structural diagram of a frame connecting portion of a backrest module in a connected status accordance with some embodiments of the present disclosure.

FIG. 4B is a structural diagram of a frame connecting portion of a backrest module and a skeleton connecting portion of a backrest skeleton in a connected status accordance with some embodiments of the present disclosure.

### REFERENCE NUMERALS

100—seat
1—backrest skeleton
11—skeleton connecting portion
111—second connecting structure
1111—first opening
1112—first opening edge
1113—second opening edge
101—area limited by the backrest skeleton
2—backrest module
21—frame
211—frame body
212—frame connecting portion
2121—first portion
21211—first connecting structure
21212—clamping member
21213—first elastic tongue
21214—second elastic tongue
21215—hook portion
21216—first portion base
2122—second portion
2123—thinned portion
22—surface cover.

### DETAILED DESCRIPTION OF EMBODIMENTS

The implementations of the present disclosure are described below by the embodiments. Embodiment of the present disclosure from the contents disclosed in the description. Although the description of the present disclosure is introduced together with other embodiments, it does not mean that the features of the present disclosure are limited to the embodiments. On the contrary, the purpose of introducing the present disclosure in combination with the embodiments is to cover other embodiments that may be extended based on the claims of the present disclosure.

In addition, the words “up”, “down”, “horizontal” and “vertical” used in the following description should be understood as the orientation shown in this paragraph and the relevant drawings. This relative term is only for convenience of explanation, and does not mean that the described device needs to be manufactured or operated in a specific direction, so it should not be understood as a limitation of the present disclosure.

It should be noted that in the following description, for example, “one embodiment”, “an embodiment”, and/or “some embodiments” refer to a feature, structure or characteristic related to at least one embodiment of the present disclosure. Therefore, it should be emphasized and noted that “an embodiment” or “one embodiment” or “one or more embodiments” mentioned twice or more in different positions in this specification do not necessarily refer to the same embodiment. In addition, some features, structures or characteristics in one or more embodiments of the present disclosure may be appropriately combined.

After in-depth research, for the above-mentioned problems, the inventors of the present disclosure provide a backrest module and a seat. By setting a frame connecting portion 212 including a first portion 2121 and a second portion 2122 connected with the first portion 2121, and the first portion 2121 and the second portion 2122 are respectively located on a first side and a second side opposite to the first side of the skeleton connecting portion 11, forming a clamping structure that the first portion 2121 and the second portion 2122 clamp a skeleton connecting portion 11, making connection between backrest skeleton 1 and backrest module 2 more reliable, and the clamping structure is also easy to disassemble, making the users easy to replace the backrest module, satisfying individual needs of the user.

The backrest module introduced in the following embodiments is suitable for automobile seat to meet users' needs such as to replace the backrest module to meet individual needs, but not limited to this, for example, it can be applied to other kinds of vehicle, such as engineering machinery, railway trains, ships, airplanes, etc. In addition, application scenes of the seat are not limited to vehicle. For example, it can also be applied to fixed places, such as conference venues, auditoriums, cinemas, etc., as long as the seats can be applied with the backrest module disclosed in the embodiments of the present disclosure.

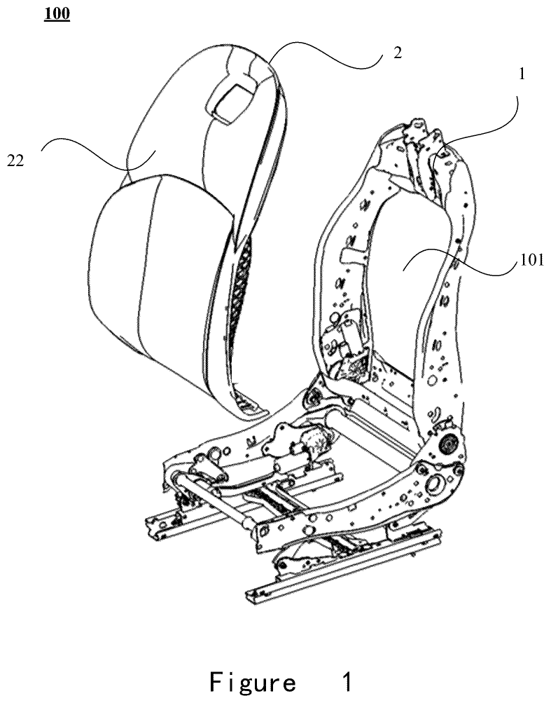

Referring to the FIG. 1, a seat 100 includes a backrest skeleton 1 and a backrest module 2, and the backrest module 2 is able to detachably connect to the backrest skeleton 1 as a whole, to form a backrest part of the seat 100. In addition, the seat 100 generally also includes a cushion part, but this is not the focus of this disclosure, so it will not be introduced in detail here.

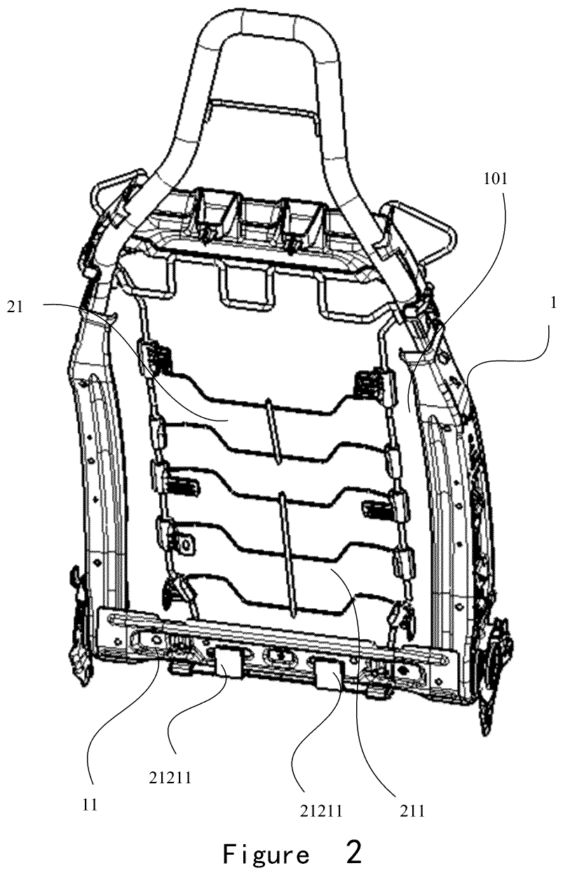

Referring to FIGS. 2, 3A, 3B, 4A and 4B, the backrest module 2 includes a frame 21, the frame 21 includes a frame body 211 and a frame connecting portion 212, and the frame body 211 is located within an area 101 limited by the backrest skeleton 1. And the frame connecting portion 212 is able to connect with a skeleton connecting portion 11 of the backrest skeleton 1, making the backrest module 2 be able to detachably connect to the backrest skeleton 1.

The frame connecting portion 212 includes a first portion 2121 and a second portion 2122 connected with the first portion 2121, and the first portion 2121 and the second portion 2122 are respectively located on a first side and a second side opposite to the first side of the skeleton connecting portion 11. For example, the second side is a front side facing the user of the seat, and the first side is a back side facing away from the user of the seat.

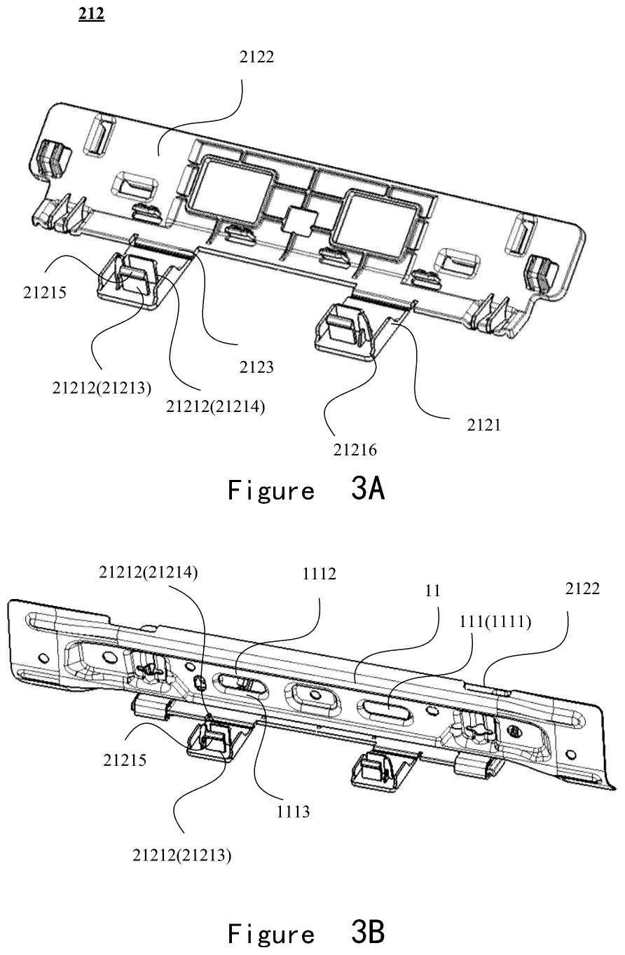

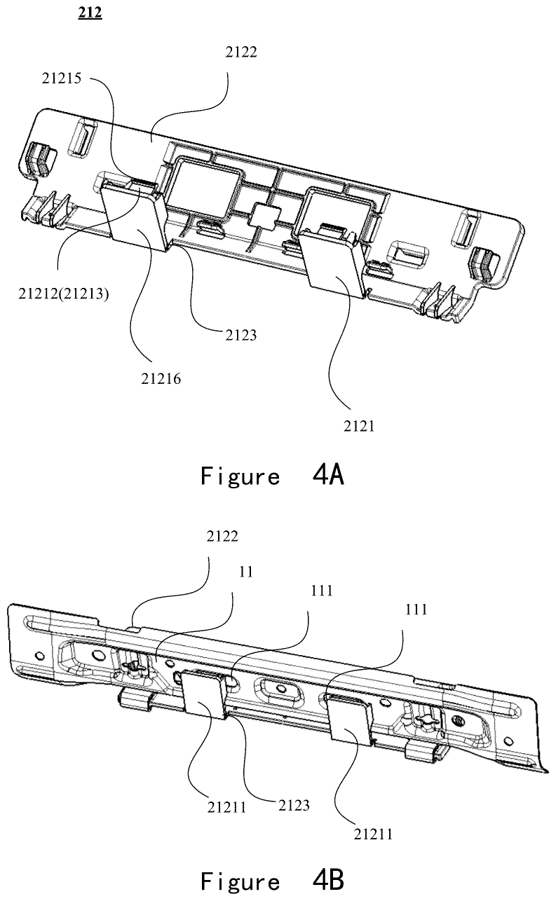

Continue to refer to FIGS. 3A, 3B, 4A, and 4B, the first portion 2121 includes a first connecting structure 21211, and the skeleton connecting portion 11 includes a second connecting structure 111. As shown in FIGS. 4A and 4b, the first connecting structure 21211 is able to correspondingly connect with the second connecting structure 111, making the frame connecting portion 212 be able to connect with the skeleton connecting portion 11 of the backrest skeleton 1.

It can be understood that the frame 21 of the backrest module 2 and the backrest skeleton 1 here are two different parts. The backrest skeleton 1 refers to a main body support of the seat. In addition, the backrest module 2 generally further includes a surface cover 22, and the surface cover 22 provides the surface of the backrest part of the seat.

The beneficial effects of adopting the above-mentioned embodiments include, but are not limited to, by the arrangement of the backrest module, backrest module of a seat can be replaced as a whole to meet the individual needs of the users. And by setting a frame connecting portion 212 including a first portion 2121 and a second portion 2122 connected with the first portion 2121, and the first portion 2121 and the second portion 2122 are respectively located on a first side and a second side opposite to the first side of the skeleton connecting portion 11, forming a clamping structure that the first portion 2121 and the second portion 2122 clamp a skeleton connecting portion 11, making connection between backrest skeleton 1 and backrest module 2 more reliable, satisfying connection strength demand of the seat especially an automobile seat, and the clamping structure is also easy to disassemble, making the users easy to replace the backrest module, satisfying individual needs of the user.

Continuing to refer to FIGS. 3A and 3B, as well as FIGS. 4A and 4B, in some embodiments, details of the first connecting structure and the second connecting structure include that, the first connecting structure 21211 includes a clamping member 21212, the second connecting structure 111 includes a first opening 1111, and the clamping member 21212 is set to engage the first opening 1111, the opening-clamping member connection is easy to assemble and reliable.

Continuing to refer to FIGS. 3A and 3B, in some embodiments, detail structure of the clamping member 21212 is that the clamping member 21212 includes a first elastic tongue 21213 and a second elastic tongue 21214 that are oppositely arranged, and the first elastic tongue 21213 and the second elastic tongue 21214 respectively engage a first opening edge 1112 and a second opening edge 1113 oppositely set to the first opening edge 1112 of the first opening 1111 by elastic force. For example, as shown in the figures, the first elastic tongue 21213 and the second elastic tongue 21214 are arranged in a relatively up-and-down directions, corresponding first opening edge 1112 and the second opening edge 1113 are upper edge and lower edge of the first opening 1111 respectively, and in the process from a disconnected status shown in FIGS. 3A and 3B to a connected status shown in FIGS. 4A and 4B, a hook portion 21215 at one end of the elastic tongue is pressed by the first opening edge 1112 and the second opening edge 1113 when passing the first opening 1111, and the elastic tongue accumulates elastic force, and after the hook portion 21215 has passes through the first opening 1111 to the second side from the first side, the first opening edge 1112 and the second opening edge 1113 release the hook portion 21215 and the elastic tongue releases the elastic force, making the first elastic tongue 21213, making the first elastic tongue 21213 and the second elastic tongue 21214 respectively engage the first opening edge 1112 and the second opening edge 1113 by elastic force. In this way, clamping effect of the clamping member 21212 is more reliable by the elastic force and/or the positioning function of the hook portion 21215.

Continuing to refer to FIGS. 3A and 3B, as well as FIGS. 4A and 4B, in some embodiments, structure that the first portion 2121 and the second portion 2122 to realize clamping skeleton connecting portion 11 is that, the first portion 2121 includes a first portion base 21216, and the clamping member 21212 is arranged on the first portion base 21216, and the first portion base 21216 is able to rotate relative to the second porting 2122, making the first connecting structure 21211 is able to be connected or disconnected from the second connecting structure 111. In some embodiments, the structure for realizing relative rotation is that the first portion base 21216 is connected with the second portion 2122 through a thinned portion 2123, and thickness of the thinned portion 2123 is thinned relative to thickness of the first portion base 21216, and the first portion base 21216 can rotate relative to the second porting 2122 with the thinned portion 2123 as a rotating shaft. It can be understood that the rotating structure can also be provided by a pivot member, but the inventors found that the strength requirements of the seat are able to be met by using the thinned portion 2123, and compared with the pivot member, the thinned portion solution reduces the number of parts and simplifies assembling and manufacturing process.

Continuing to refer to FIGS. 3A and 3B, as well as FIGS. 4A and 4B, in some embodiments, the second portion 2122 and the skeleton connecting portion 11 are both plate-shaped structure. The plate-shaped structure described here is not a strictly flat plate structure, for example, as shown in the figures, the plate-shaped structure can also have concaves. The beneficial effect of the second portion 2122 and the skeleton connecting portion 11 are plate-shaped structures is that the clamping effect is better, and connection between the backrest module 2 and the backrest skeleton 1 is more reliable.

In some embodiments, as described above, the backrest module 2 further includes a surface cover 22, and part of the surface cover 22 is located between the first side of the skeleton connecting portion 11 and the first portion 2121, and when the first connecting structure 21211 is connected with the second connecting structure 111, part of the surface cover 22 is located between the first connecting structure 21211 and the second connecting structure 111, making the first connecting structure 21211 and the second connecting structure 111 be arranged without direct contact. In this way, noise produced by connecting and assembling the first connecting structure 21211 and the second connecting structure 111 is reduced and use noise is also reduced in the actual seat use after connecting and assembling, and user experience is further improved.

In some embodiments, as described above, the disclosure also provides a disassembling and assembling method for a seat, being configured for the seat 100 of above embodiments, and the backrest module 2 includes a frame 21 and a surface cover 22, and the disassembling and assembling method includes: connecting or disconnecting the first connecting structure 21211 from the second connecting structure 111 to assemble or disassemble the backrest module 2 with the backrest skeleton 1. This makes it easy for the user to disassemble and assemble the backrest module 2.

In addition, as described above, the backrest module 2 can be employed as an independent component, for example, one single seat is able to correspond to different backrest modules 2, and the user can replace different backrest modules 2 according to their own individual needs. That is, the backrest module is able to detachably connect to a backrest skeleton 1 as a whole to form a backrest part of the seat 100, and the backrest module 2 includes a frame 21, and the frame 21 includes a frame body 211 and a frame connecting portion 212, and the frame body 211 being located within an area 101 limited by the backrest skeleton 1; and the frame connecting portion 212 is able to connect with a skeleton connecting portion 11 of the backrest skeleton 1, making the backrest module 2 be able to detachably connect to the backrest skeleton 1; and the frame connecting portion 212 includes a first portion 2121 and a second portion 2122 connected with the first portion 2121, and the first portion 2121 and the second portion 2122 being respectively located on a first side and a second side opposite to the first side of the skeleton connecting portion 11; and the first portion 2121 includes a first connecting structure 21211, and the skeleton connecting portion 11 includes a second connecting structure 111; and the first connecting structure 21211 being able to correspondingly connect with the second connecting structure 111, making the frame connecting portion 212 be able to connect with the skeleton connecting portion 11 of the backrest skeleton 1. As described above, in some embodiments, the backrest module 2 further includes a surface cover 22, and the surface cover 22 is located on a side which the first portion 2121 corresponds to the skeleton connecting portion 11 and the cover 22 extends to an area corresponding to the first portion 2121.

To sum up, beneficial effects of employing the seat, the disassembling and assembling method and the backrest module introduced in the above embodiments include, but are not limited to, By setting a frame connecting portion 212 including a first portion 2121 and a second portion 2122 connected with the first portion 2121, and the first portion 2121 and the second portion 2122 are respectively located on a first side and a second side opposite to the first side of the skeleton connecting portion 11, forming a clamping structure that the first portion 2121 and the second portion 2122 clamp a skeleton connecting portion 11, making connection between backrest skeleton 1 and backrest module 2 more reliable, and the clamping structure is also easy to disassemble, making the users easy to replace the backrest module, satisfying individual needs of the user.

Although the above embodiments of the present disclosure are disclosed as above, they are not used to limit the present disclosure. Therefore, any amendments, equivalent changes and modifications made to the above embodiments of the present disclosure without departing from the proposal of the present disclosure fall within the scope of protection defined in the claims of the present disclosure.

1. A seat, comprising:
a backrest skeleton;
a backrest module, being able to detachably connect to the backrest skeleton as a whole, to form a backrest part of the seat;
wherein the backrest module comprises a frame, and the frame comprises a frame body and a frame connecting portion, and the frame body is located within an area limited by the backrest skeleton; and the frame connecting portion is able to connect with a skeleton connecting portion of the backrest skeleton, making the backrest module be able to detachably connect to the backrest skeleton;
and the frame connecting portion comprises a first portion and a second portion connected with the first portion, and the first portion and the second portion are respectively located on a first side and a second side opposite to the first side of the skeleton connecting portion;
and the first portion comprises a first connecting structure, and the skeleton connecting portion comprises a second connecting structure;
and the first connecting structure is able to correspondingly connect with the second connecting structure, making the frame connecting portion be able to connect with the skeleton connecting portion of the backrest skeleton.

2. The seat of claim 1, wherein the first connecting structure comprises a clamping member, the second connecting structure comprises a first opening, and the clamping member is set to engage the first opening.

3. The seat of claim 2, wherein the clamping member comprises a first elastic tongue and a second elastic tongue that are oppositely arranged, and the first elastic tongue and the second elastic tongue respectively engage a first opening edge and a second opening edge oppositely set to the first opening edge of the first opening by elastic force.

4. The seat of claim 2, wherein the first portion comprises a first portion base, and the clamping member is arranged on the first portion base, and the first portion base is able to rotate relative to the second porting, making the first connecting structure is able to be connected or disconnected from the second connecting structure.

5. The seat of claim 4, wherein the first portion base is connected with the second portion through a thinned portion, and thickness of the thinned portion is thinned relative to thickness of the first portion base, and the first portion base can rotate relative to the second porting with the thinned portion as a rotating shaft.

6. The seat of claim 1, wherein the second portion and the skeleton connecting portion are both plate-shaped structure.

7. The seat of claim 1, wherein the backrest module further comprises a surface cover, and part of the surface cover is located between the first side of the skeleton connecting portion and the first portion, and when the first connecting structure is connected with the second connecting structure, part of the surface cover is located between the first connecting structure and the second connecting structure, making the first connecting structure and the second connecting structure be arranged without direct contact.

8. A disassembling and assembling method for a seat, being used for the seat of claim 1, and the backrest module comprising a frame and a surface cover, and the disassembling and assembling method comprising: connecting or disconnecting the first connecting structure from the second connecting structure to assemble or disassemble the backrest module with the backrest skeleton.

9. A backrest module, being able to detachably connect to a backrest skeleton as a whole to form a backrest part of a seat, and the backrest module comprising a frame, and the frame comprising a frame body and a frame connecting portion, and the frame body being located within an area limited by the backrest skeleton; and the frame connecting portion being able to connect with a skeleton connecting portion of the backrest skeleton, making the backrest module be able to detachably connect to the backrest skeleton; and the frame connecting portion comprises a first portion and a second portion connected with the first portion, and the first portion and the second portion being respectively located on a first side and a second side opposite to the first side of the skeleton connecting portion; and the first portion comprising a first connecting structure, and the skeleton connecting portion comprising a second connecting structure; and the first connecting structure being able to correspondingly connect with the second connecting structure, making the frame connecting portion be able to connect with the skeleton connecting portion of the backrest skeleton.

10. The backrest module of claim 9, wherein it further comprises a surface cover, and the surface cover is located on a side which the first portion corresponds to the skeleton connecting portion and the cover extends to an area corresponding to the first portion.
